(19) United States
(12) Patent Application Publication
(10) Pub. No.: US 2021/0284069 A1
(43) Pub. Date: Sep. 16, 2021

(54) VEHICLE DISPLAY DEVICE

(71) Applicant: Maxell Frontier Co., Ltd., Kanagawa (JP)

(72) Inventors: Kazuma SHIMANOKI, Kanagawa (JP); Takako TAKEDA, Kanagawa (JP); Shinji NAGAOKA, Kanagawa (JP)

(21) Appl. No.: 17/259,041

(22) PCT Filed: Jun. 28, 2019
(86) PCT No.: PCT/JP2019/025953

§ 371 Date: Jan. 8, 2021

(30) Foreign Application Priority Data
Jul. 13, 2018 (JP) 2018-133154

(51) Int. Cl. B60R 1/12; B60R 11/04; G06F 3/042

(52) U.S. Cl. CPC B60R 1/12; B60R 21/01532; G06F 3/0425; B60R 11/04

(57) ABSTRACT

A vehicle display device provided in a vehicle includes a display 33 and a controller. The controller displays a video showing a side view and a rear view from a vehicle 1 on the display 33 when a passenger gets out of the vehicle 1 while the vehicle 1 is stopped.

### TECHNICAL FIELD

The present invention relates to a vehicle display device.

### BACKGROUND ART

When a vehicle is running, the driver's view is obstructed by pillars near a driver's seat and a passenger seat. For this reason, a technology to notify the driver of the information about the regions to be blind spots of the pillars has been proposed.

For example, Patent Document 1 discloses a vehicle visibility assisting device which allows a driver to accurately grasp the situation around a vehicle. Specifically, an in-vehicle camera capable of shooting the front of a vehicle is attached to a door mirror on a side of the driver's seat of the vehicle. In addition, a display is attached to a surface of the front pillar near the driver's seat inside the vehicle. A part of the video taken by the in-vehicle camera, which corresponds to the part of the driver's view obstructed by the front pillar, is cut out and displayed on the display.

Further, Patent Document 2 discloses a vehicle visual assisting system in which a control device has a function of determining whether or not an obstacle is present in a blind spot region. When the control device determines that an obstacle is present in the blind spot region, the control device emits an alarm sound via a speaker.

### RELATED ART DOCUMENTS

### Patent Documents

Patent Document 1: Japanese Patent Application Laid-open Publication No. 2008-155701

Patent Document 2: Japanese Patent Application Laid-open

Publication No. 2012-34076

### SUMMARY OF THE INVENTION

### Problems to be Solved by the Invention

As described above, by providing the information about the region to be the blind spot while the vehicle is running, the safety in driving a vehicle is ensured. On the other hand, when getting out of a vehicle, it is necessary to visually confirm the safety behind the vehicle, such as the presence or absence of a following vehicle. However, depending on the structure of the vehicle and the riding posture, it may be difficult to visually confirm the safety behind the vehicle.

Therefore, an object of the present invention is to reliably confirm the situation around a vehicle when getting out of the vehicle.

### Means for Solving the Problems

An outline of a typical invention disclosed in this application will be briefly described as follows.

A vehicle display device according to a typical embodiment of the present invention comprises a display and a controller. The controller displays a first video showing a side view and a rear view from a vehicle on the display when a passenger gets out of the vehicle while the vehicle is stopped.

### Effects of the Invention

The effects obtained by the typical invention disclosed in this application will be briefly described below.

Namely, according to a typical embodiment of the present invention, it is possible to provide a vehicle display device capable of reliably confirming the situation around a vehicle when getting out of the vehicle.

### BRIEF DESCRIPTIONS OF THE DRAWINGS

FIG. 1 is a diagram showing a principal part of an example of a vehicle including a vehicle display device according to the first embodiment of the present invention in an enlarged manner;

FIG. 2 is a block diagram showing an example of a configuration of the vehicle display device according to the first embodiment of the present invention;

FIG. 3 is a diagram showing an example of camera installation positions;

FIG. 4 is a diagram showing details of the camera installation position;

FIG. 5 is a diagram showing a video display region when viewed from a left side of the vehicle;

FIG. 6 is a flowchart of a video display method according to the first embodiment of the present invention;

FIG. 7 is a diagram showing an example of camera insulation positions according to a modification of the present invention;

FIG. 8 is a plan view showing video display regions according to the second embodiment of the present invention;

FIG. 9 is a flowchart of a video display method according to the second embodiment of the present invention; and

FIG. 10 is a diagram showing an example of a display installation position according to the third embodiment of the present invention.

### DETAILED DESCRIPTION OF PREFERRED EMBODIMENTS

Hereinafter, best modes for implementing the present invention will be described in detail with reference to drawings. Note that components having the same function are denoted by the same reference signs throughout the drawings for describing the best modes for implementing the invention, and the repetitive description thereof will be omitted.

### First Embodiment

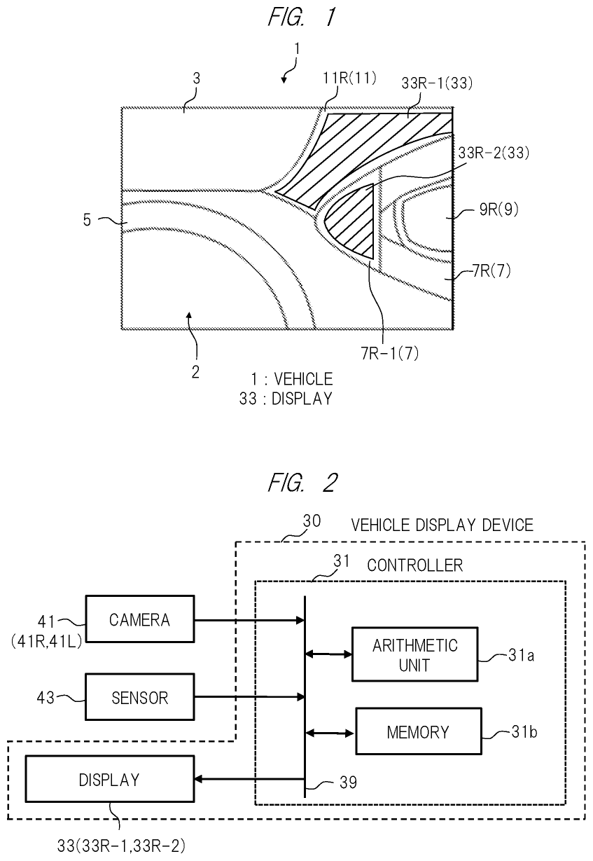

FIG. 1 is a diagram showing a principal part of an example of a vehicle including a vehicle display device according to the first embodiment of the present invention in an enlarged manner. Specifically, FIG. 1 is a diagram showing an example of a configuration around a driver's seat. As shown in FIG. 1, a steering wheel 5 is provided in front of a seating (not shown) of a driver's seat 2 of a vehicle 1.

A windshield 3 is provided in front of the steering wheel 5. Further, a side glass 7R is provided on a right side of the steering wheel 5. A pillar portion 11R is provided between the windshield 3 and the side glass 7R. The pillar portion 11R is arranged so as to protrude forward from an upper end of the windshield 3 to a lower end thereof . Also, the side glass 7R is configured such that a width thereof becomes smaller as it gets closer to a lower end of the pillar portion 11R from an upper end thereof.

A display 33R-1 is installed in the pillar portion 11R. The display 33R-1 may be installed so as to cover almost all the region of the pillar portion 11R as shown in FIG. 1, or may be installed so as to cover only a part of the region thereof. Also, as shown in FIG. 1, a display 33R-2 may also be installed in a tip end portion 7R-1 of the side glass 7R near the lower end of the pillar portion 11R. Note that the display 33R-2 is arranged at the position where the visibility of a door mirror 9R by the driver is not disturbed.

Although FIG. 1 shows only the configuration of the side of the driver's seat 2, displays are installed in a pillar portion and a tip end portion of a side glass also on a side of a passenger seat (not shown) in the same manner as that on the side of the driver's seat 2.

FIG. 2 is a block diagram showing an example of a configuration of the vehicle display device according to the first embodiment of the present invention. As shown in FIG. 2, a vehicle display device 30 includes a display 33 (33R-1, 33R-2, and the like) and a controller 31.

The display 33 is composed of a liquid crystal panel or an OLED (Organic Light-Emitting Diode) display. Alternatively, the displays 33R-1 and 33R-2 may be composed of an EPD (Electrophoretic Display) other than these. The display 33 displays a video or the like taken by a camera 41 based on the control of the controller 31.

As shown in FIG. 2, the controller 31 includes an arithmetic unit 31a and a memory 31b. The memory 31b includes, for example, a volatile memory such as a DRAM (Dynamic Random. Access Memory) or an SRAM (Static RAM), and develops various programs for video processing and video displaying read from a data storage unit (not shown). Further, the memory 31b develops video data output from the camera 41.

The arithmetic unit 31a is composed of, for example, a computer such as a CPU. The arithmetic unit 31a implements various functions such as video processing and video displaying by executing a program developed in the memory 31b. Further, the arithmetic unit 31a performs image processing using the video data developed in the memory 31b.

The controller 31 may be connected to the display 33, the camera 41, and a sensor 43 via an internal bus 39 as shown in FIG. 2, or may be individually connected to the display 33, the camera 41, and the sensor 43.

The various functions of the controller 31 may be realized by, for example, an ECU (Electronic Control Unit) or a controller of a car navigation device.

FIG. 3 is a diagram showing an example of camera installation positions. FIG. 3 shows a plan view of the vehicle 1 as viewed from above. Further, FIG. 3 also shows shooting regions of the cameras 41 when viewed from above. As shown in FIG. 3, the camera 41 is installed in each door mirror 9 of the vehicle. For example, a camera 41R is installed in a right door mirror 9R, and a camera 41L is installed in a left door mirror 9L.

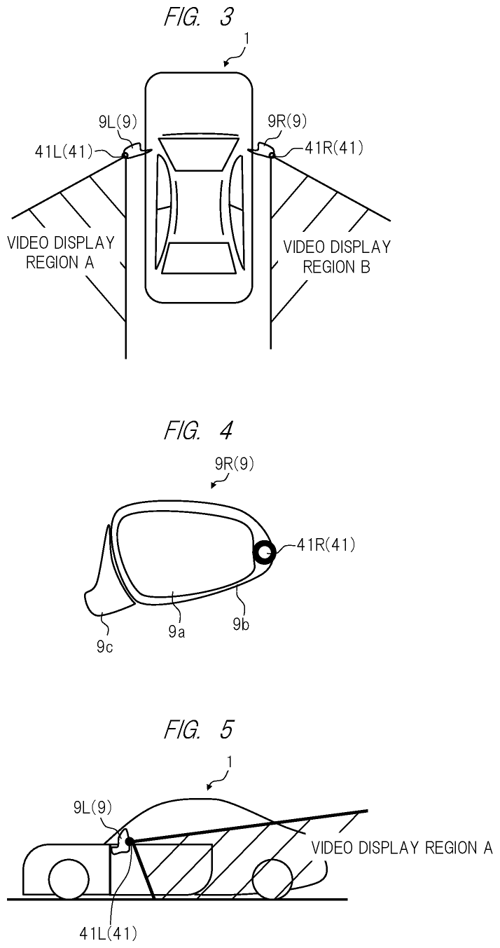

FIG. 4 is a diagram showing details of the camera installation position. FIG. 4 shows the details of the installation position of the camera 41R with taking the right door mirror 9R as an example. As shown in FIG. 4, the door mirror 9R has a mirror portion 9a, a mirror housing portion 9b, and a mounting portion 9c. The door mirror 9R is attached to the vehicle 1 via the mounting portion 9c. The mirror housing portion 9b houses the mirror portion 9a. Further, in a frame region of the mirror housing portion 9b surrounding the mirror portion 9a, the camera 41R is installed in the region on an opposite side to the mounting portion 9c. Note that the camera 41L is also installed in the left door mirror 9L at a position symmetrical to the door mirror 9R.

As shown in FIG. 3, the camera 41R takes video (first video) of a video display region B on the right side and the rear right side of the vehicle 1 and outputs the video data to the controller 31. On the other hand, the camera 41L takes video (first video) of a video display region A on the left side and the left rear side of the vehicle 1 and outputs the video data to the controller 31.

FIG. 5 is a diagram showing the video display region when viewed from a left side of the vehicle. Specifically, FIG. 5 shows the video display region on the side of the camera 41L in the vertical direction. As shown in FIG. 5, the camera 41L shoots a region extending slightly upward with respect to the horizontal direction from a floor surface near the door of the vehicle 1. Although not shown, the right camera 41R also shoots the region similar to that of the camera 41L. As described above, the video display regions B and A corresponding to the cameras 41R and 41L cover the regions where the passenger should visually confirm the safety when getting out of the vehicle.

The sensor 43 is a device that detects the contact of the passenger with a doorknob of the vehicle 1. Namely, the sensor 43 detects the action of the passenger trying to get out of the vehicle 1. The sensor 43 is mounted on each doorknob of the vehicle 1. The sensor 43 is composed of, for example, various types of sensors such as a so-called pressure-sensitive sensor, and outputs a doorknob contact signal indicating that a passenger is getting out of the vehicle, to the controller 31 when the passenger touches the sensor 43.

In this embodiment, the action of the passenger trying to get out of the vehicle is detected by detecting the contact of the passenger with the doorknob by the sensor 43 mounted on the doorknob, but another configuration may be adopted as a matter of course. For example, the configuration in which the controller 31 detects the action of getting out of the vehicle by detecting the pulling out of a key for stopping and starting an engine from a key insertion slot (not shown) is possible, or the configuration in which the controller 31 detects the action of getting out of the vehicle by detecting the movement of a shift lever (not shown) to “Parking” (P) is also possible. Of course, these configurations may be combined as appropriate.

<Video Display Method at Getting Out of Vehicle>

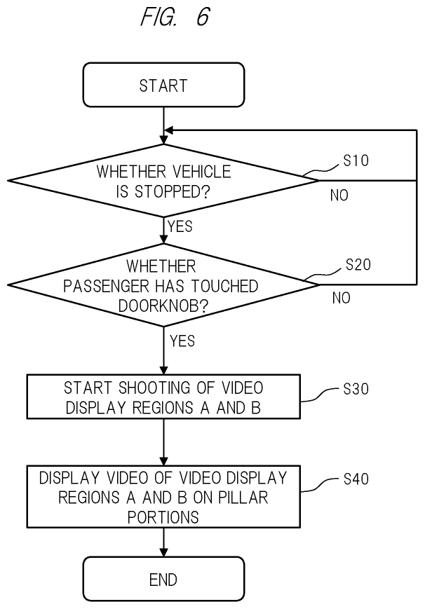

Next, a video display method at getting out of a vehicle will be described. FIG. 6 is a flowchart of a video display method according to the first embodiment of the present invention. First, in step S10, it is determined whether or not the vehicle 1 is stopped. For example, the controller 31 acquires speed information from the vehicle 1 and determines whether or not the vehicle 1 is stopped based on the acquired speed information. When the speed of the vehicle 1 is not zero, the controller 31 determines that the vehicle 1 is not stopped (NO), and the process of step S10 is performed again.

On the other hand, when the speed of the vehicle 1 is zero, the controller 31 determines that the vehicle 1 is stopped (YES), and the process of step S20 is performed.

In step S20, it is determined whether or not the passenger has touched the doorknob. When the doorknob contact signal is not output from the sensor 43, the controller 31 determines that the passenger has not touched the doorknob (NO), and the processes of steps S10 and S20 are performed again. On the other hand, when the doorknob contact signal is output from the sensor 43, the controller 31 determines that the passenger has touched the doorknob (YES), and the process of step S30 is performed. Namely, in this case, the controller 31 determines that the passenger is getting out of the vehicle 1.

In step S30, the cameras 41 (41R, 41L) shoot the video of the side view and rear view from the vehicle 1. The controller 31 outputs a camera driving signal and causes the cameras 41 to shoot the video.

In step S40, the video taken by the cameras 41 is displayed on the displays 33. The controller 31 performs the image processing on the video data output from the cameras 41 and then displays it on the displays 33. The image processing performed here includes, for example, a process of forming an image for displaying in accordance with the shape of the displays 33.

For example, the controller 31 displays the video taken by the right camera 41R of the vehicle 1 on the displays 33R-1 and 33R-2 on the side of the driver's seat, and displays the video taken by the left camera 41L of the vehicle 1 on the display 33 on the side of the passenger seat . The passenger gets out of the vehicle 1 while watching the video displayed on the display 33. In this embodiment, the video taken by the camera 41 is displayed on the display 33 installed in the pillar portion 11. Alternatively, it is also possible to install a head-up display (HUD) (not shown) in the vehicle 1 and project and display the video taken by the camera 41 by this HUD on the windshield 3 of the vehicle 1 or a combiner or a screen arranged between the windshield 3 and the driver's seat. In this case, the windshield 3, the combiner, and the screen on which the video is projected function as a display.

When the door is closed after the passenger gets out of the vehicle, the controller 31 may stop the shooting by the camera 41 or may continue the shooting.

Here, the case where the video is taken by the cameras 41R and 41L on both sides has been described. Alternatively, for example, the video may be taken only by the left camera 41L when the passenger touches the sensor 43 on the side of the passenger seat. On the other hand, the video may be taken only by the right camera 41R when the passenger touches the sensor 43 on the side of the driver's seat. Also, for example, the case where a passenger touches the sensor 43 on one side (for example, on the side of the driver's seat) while another passenger is getting out from the door on the other side (for example, on the side of the passenger seat) is assumed. In such a case, the controller 31 may have the corresponding cameras 41 shoot the video when the passengers touch the respective sensors 43.

<Main Effects of this Embodiment>

According to this embodiment, the controller 31 displays the video of the side view and the rear view from the vehicle 1 on the display 33 when the passenger gets out of the vehicle 1 while the vehicle 1 is stopped. Specifically, when the passenger touches the sensor 43, the controller 31 causes the display 33 to display the video. With this configuration, the passenger who is getting out of the vehicle can see the video displayed on the display 33, so that it is possible to reliably confirm the situation around the vehicle at the time of getting out of it. Further, this enables the passenger to safely get out of the vehicle 1.

Further, according to this embodiment, the display 33 is composed of a liquid crystal panel or an OLED display. Since these panels are readily available, the manufacturing cost can be reduced.

Further, according to this embodiment, the display 33 is composed of an EPD. Since the EPD is easy to bend, it can be reliably installed in accordance with the shape of the installation position.

Further, according to this embodiment, the display 33 is installed in the pillar portion 11R on the side of the driver's seat 2. With this configuration, the driver can easily confirm the situation around the vehicle.

Further, according to this embodiment, the display 33 is installed in the pillar portion on the side of the passenger seat. Normally, even when getting out of the vehicle from the passenger seat, the passenger who is getting out of the vehicle can easily confirm the situation around the vehicle 1.

[Modification]

Here, a modification of this embodiment will be described. Many vehicles are equipped with an open/close button for opening and closing the door mirrors and a door mirror opening/closing mechanism for opening and closing the door mirrors by the operation of the open/close button. When getting out of the vehicle, the driver often closes the door mirrors by operating the open/close button in order to protect the door mirrors. If the door mirrors are closed when getting out of the vehicle, it becomes impossible to confirm the sides and rear of the vehicle (that is, the regions corresponding to the video display regions A and B) through the door mirrors.

Therefore, it is more preferable to display the side view and the rear view from the vehicle on the display 33 even when the door mirrors are closed. This can be achieved by mounting the cameras 41 in the door mirrors 9 at the position or the angle capable of shooting the side view and the rear view from the vehicle even when the door mirrors 9 are closed. Alternatively, this can be achieved also by installing a camera angle variable mechanism that changes the angles of the cameras 41 in conjunction with the opening and closing of the door mirrors 9. By adjusting the angles of the cameras 41 by the camera angle variable mechanism, the cameras 41 can shoot the same regions on the sides and the rear of the vehicle regardless of whether the door mirrors are open or closed.

Alternatively, other cameras whose angles are adjusted so as to be able to shoot the sides and the rear of the vehicle when the door mirrors 9 are closed may be installed in the door mirrors 9 in addition to the cameras 41. For example, these cameras may be installed near the cameras 41.

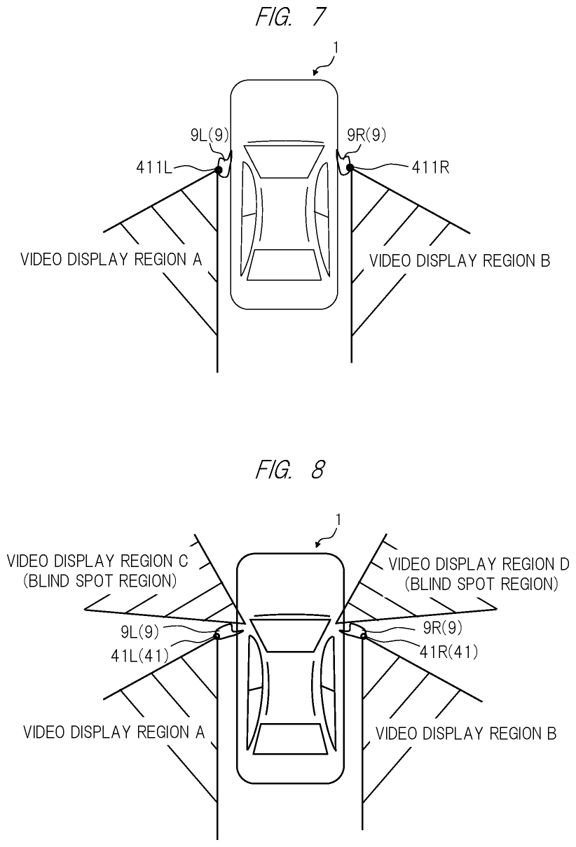

FIG. 7 is a diagram showing an example of camera insulation positions according to the modification of the present invention. Note that illustrations of the cameras 41 (41R, 41L) shown in FIG. 3 and the like are omitted in FIG. 7. As shown in FIG. 7, for example, cameras 411R and 411L are installed on the back side of the mirror housing portions 9b of the door mirrors 9R and 9L (the surfaces opposite to the mirror portions 9a of the door mirrors 9), respectively.

When the door mirror 9R is closed, the camera 411R takes the video of the video display region B and outputs the video data to the controller 31. On the other hand, when the door mirror 9L is closed, the camera 411L takes the video of the video display region A and outputs the video data to the controller 31.

In this way, when the door mirrors 9 are closed, the cameras 411R and 411L can suitably shoot the sides and the rear of the vehicle.

Note that the cameras 411R and 411L may be activated to shoot the sides and rear of the vehicle only when the door mirrors 9 are closed, instead of being always activated.

With the configuration or arrangement of the cameras described above, even when the door mirrors 9 are closed at the time of getting out of the vehicle, the situation of the sides and the rear of the vehicle 1 can be confirmed on the displays 33, so that it is possible to easily confirm the situation around the vehicle 1 when getting out of the vehicle while protecting the door mirrors 9.

### Second Embodiment

Next, the second embodiment will be described. In this embodiment, the video displayed on the display is switched in accordance with whether the vehicle is running or stopped.

Specifically, when the vehicle is running, a video (second video) of the blind spot region for the driver by the pillar portion 11 of the vehicle 1 is displayed on the display 33. On the other hand, when the passenger gets out of the vehicle 1 while the vehicle is stopped, the video taken by the camera 41 is displayed on the display 33.

A blind spot shooting camera (not shown) that shoots a region to be a blind spot for the driver is installed in the vehicle 1. The blind spot regions obstructed by the pillar portions 11 are present on the side of the driver's seat 2 and the side of the passenger seat, respectively. Therefore, the blind spot shooting cameras are installed so as to correspond to the respective blind spot regions. Note that the blind spot shooting cameras may be installed inside the vehicle 1 or may be installed outside the vehicle 1.

Further, it is also possible to deal with a plurality of blind spot regions by only one blind spot shooting camera. In this case, the controller 31 performs video processing to generate video corresponding to respective blind spot regions from one video data.

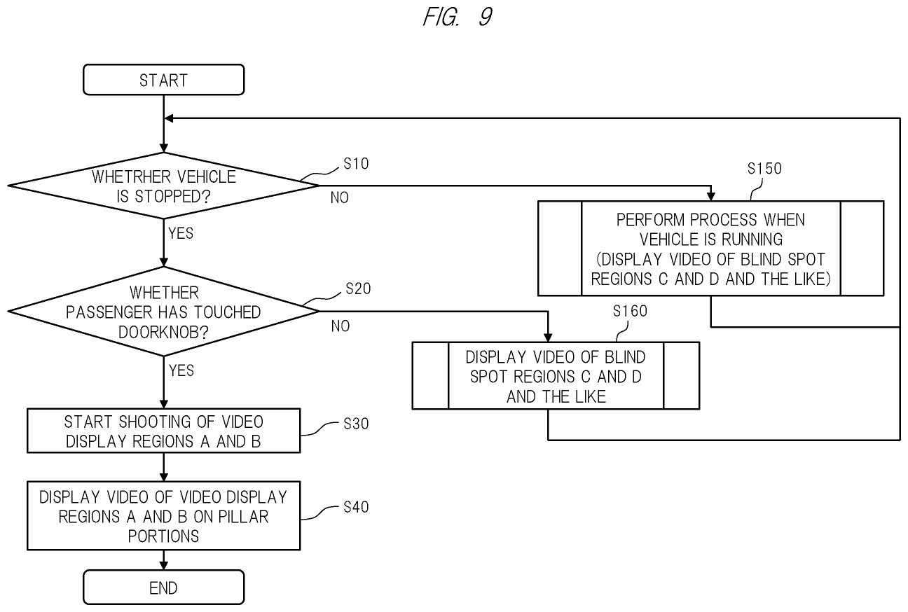

FIG. 8 is a plan view showing video display regions according to the second embodiment of the present invention. FIG. 8 shows the video display regions A and B described in the first embodiment and video display regions C and D corresponding to the blind spot regions. The video display region C is a blind spot region corresponding to the pillar on the side of the passenger seat, and the video display region D is a blind spot region corresponding to the pillar portion 11R on the side of the driver's seat 2. In the following, the video display regions C and D may be referred to as blind spot regions C and D.

<Video Display Method>

Next, a video display method according to this embodiment will be described. FIG. 9 is a flowchart of the video display method according to the second embodiment of the present invention.

«Just Before Start of Driving»

First, the descriptions of the flowchart will be given with taking the state just before the start of driving, that is, just before the running of the vehicle 1 as the initial state. When it is determined in step S10 that the vehicle 1 is stopped, the process of step S20 is performed. When it is determined in step S20 that the passenger has not touched the doorknob (NO), the process of step S160 is performed.

In step S160, the video taken by the blind spot shooting cameras is displayed on the displays 33. The controller 31 performs the image processing on the video data output from the blind spot shooting cameras, and then causes the displays 33 to display the blind spot regions C and D. Thereafter, the flow returns to step

S10.

When it is determined in repeated step S10 that the vehicle 1 is not stopped (NO), the process of step S150 is performed. In step S150, processing to display the blind spot regions C and D on the displays 33 is continuously performed. When the process of step S150 is completed, the flow returns to step S10.

When it is determined in step S20 that the passenger has touched the doorknob (YES), the process of step S30 is performed. Since the process of step S30 has already been described, the description thereof is omitted here.

In step S40, the video displayed on the displays 33 is switched from the video of the blind spot regions C and D to the video taken by the cameras 41. At that time, the controller 31 may stop the shooting operation by the blind spot shooting cameras, or may continue the shooting operation.

«Case where Vehicle is Restarted after Passenger Gets Out of Vehicle»

Next, the case where the vehicle is restarted after the passenger gets out of the vehicle will be described based on this flowchart while applying the case classification.

(1) When it is determined in step S10 that the vehicle 1 is not stopped (NO), the process of step S150 is performed. At this time, the video of the video display regions A and B is displayed on the displays 33. Thus, in step S150, the controller 31 switches the video displayed on the displays 33 to the video of the blind spot regions C and D. Then, the flow returns to step S10.

(2) On the other hand, when it is determined in step S10 that the vehicle 1 is stopped (YES), the process of step S20 is performed. When it is determined in step S20 that the passenger has not touched the doorknob (NO), the process of step S160 is performed. In step S160 at this time, the controller 31 switches the video displayed on the displays 33 from the video of the video display regions A and B to the video of the blind spot regions C and D. Then, the flow returns to step S10.

(3) When it is determined in step S10 that the vehicle 1 is stopped (YES) and it is determined in step S20 that the passenger has touched the doorknob (YES), the processes of steps S30 and S40 are performed. At this time, the video of the video display regions

A and B is displayed on the displays 33. Therefore, any special processing is not performed in steps S30 and S40, and the video of the video display regions A and B is continuously displayed.

<Main Effects of this Embodiment>

According to this embodiment, the video of the blind spot regions C and D is displayed on the displays 33 while the vehicle 1 is running, and the video of the video display regions A and B is displayed on the displays 33 when the passenger gets out of the vehicle 1. With this configuration, the video displayed on the displays 33 is switched between the case when the vehicle is running and the case when the vehicle is stopped, so that the convenience can be improved.

### Third Embodiment

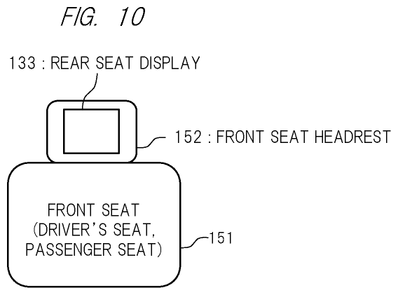

Next, the third embodiment will be described. In this embodiment, a case where a display for a rear seat is installed will be described. FIG. 10 is a diagram showing an example of a display installation position according to the third embodiment of the present invention. FIG. 10 shows a front seat 151, a front seat headrest 152, and a rear seat display 133.

As shown in FIG. 10, the front seat headrest 152 is connected to an upper end of the front seat 151. Then, the rear seat display 133 is installed in the front seat headrest 152. The rear seat display 133 may be installed in the front seat 151. Further, the front seat 151 does not limit the driver's seat or the passenger seat. Namely, the rear seat display 133 is also provided on the back side of the driver's seat and the back side of the passenger seat.

The rear seat display 133 installed on the side of the driver's seat displays the video of the video display region B taken by the camera 41R, the video of the blind spot region D, and the like. On the other hand, the rear seat display 133 provided on the side of the passenger seat displays the video of the video display region A taken by the camera 41L, the video of the blind spot region C, and the like.

Like the display 33, the rear seat display 133 is composed of a liquid crystal panel, an OLED display, an EPD, or the like. On the other hand, the shape of the rear seat display 133 is not particularly limited unlike the display 33. Therefore, the rear seat display 133 is formed in, for example, a rectangular shape or a square shape.

According to this embodiment, the rear seat display 133 is installed on the back side of the driver's seat and the passenger seat. With this configuration, even when getting out of the vehicle from the rear seat, it is possible to reliably confirm the situation around the vehicle.

In recent years, so-called side-mirrorless vehicles without side mirrors in which side mirrors are replaced by the cameras which shoot the rear view from the vehicle and the displays which are installed in the vehicle and display the video taken by the cameras have been sold. It is of course possible to implement the present invention by using the cameras replacing the side mirrors in such a side-mirrorless vehicle.

Note that the present invention is not limited to the above-described embodiments, and includes various modifications. Further, the embodiments above have been described in detail in order to make the present invention easily understood, and the present invention is not necessarily limited to that including all the described configurations.

Also, a part of the configuration of one embodiment may be replaced with the configuration of another embodiment, and the configuration of one embodiment may be added to the configuration of another embodiment. Furthermore, another configuration may be added to a part of the configuration of each embodiment, and a part of the configuration of each embodiment may be eliminated or replaced with another configuration. It is needless to say that the embodiments can be combined as appropriate. The members and relative size shown in the drawings are simplified and idealized for describing the present invention in an easily understandable manner, and they may have more complicated shape in actual device.

### REFERENCE SINGS LIST

1 vehicle

11, 11R pillar portion,

30 vehicle display device,

31 controller,

33, 33R-1, 33R-2 display,

43 sensor,

133 rear seat display

1. A vehicle display device provided in a vehicle, comprising:
a display; and
a controller,
wherein the controller displays a first video showing a side view and a rear view from the vehicle on the display when a passenger gets out of the vehicle while the vehicle is stopped.

2. The vehicle display device according to claim 1,
wherein the controller displays the first video on the display when the passenger touches a sensor mounted on a doorknob of the vehicle.

3. The vehicle display device according to claim 1,
wherein the controller displays a second video of a region to be a blind spot for a driver by a pillar portion of the vehicle on the display when the vehicle is running, and displays the first video on the display when the passenger gets out of the vehicle.

4. The vehicle display device according to claim 1,
wherein the display is installed in a pillar portion on a side of a driver's seat.

5. The vehicle display device according to claim 1,
wherein the display is installed in a pillar portion on a side of a passenger seat.

6. The vehicle display device according to claim 1,
wherein the display for a rear seat is installed on a back side of a driver's seat.

7. The vehicle display device according to claim 1,
wherein the display for a rear seat is installed on a back side of a passenger seat.

8. The vehicle display device according to claim 1,
wherein the display is a liquid crystal panel or an OLED (Organic Light-Emitting Diode) display.

9. The vehicle display device according to claim 1,
wherein the controller displays the first video on the display when detecting a stop of an engine of the vehicle, pulling out of a key for starting the engine from a key insertion slot, or movement of a shift lever of the vehicle to parking.

10. The vehicle display device according to claim 1, further comprising a head-up display,
wherein the head-up display projects and displays the first video on a combiner, a screen, or a windshield functioning as the display.
